(19) United States
(12) Patent Application Publication
(10) Pub. No.: US 2014/0081973 A1
(43) Pub. Date: Mar. 20, 2014

(54) SPIKE CLASSIFICATION

(71) Applicants: Mukund Jha, Jersey City, NJ (US); Kumar Mayur Thakur, West Orange, NJ (US)

(72) Inventors: Mukund Jha, Jersey City, NJ (US); Kumar Mayur Thakur, West Orange, NJ (US)

(73) Assignee: Google Inc., Mountain View, CA (US)

(21) Appl. No.: 13/617,260

(22) Filed: Sep. 14, 2012

(51) Int. Cl. G06F 17/30

(52) U.S. Cl. 707/737; 707/E17.089

(57) ABSTRACT

Methods, systems, and apparatus, including computer programs encoded on computer storage media, for classifying a spike in a rate of occurrence of events. One of the methods includes receiving data identifying a spike at a particular time in a rate of occurrence of events relating to a particular search query, where an event relating to the particular search query is a receipt event of the particular search query or an indexing event of a resource that satisfies the particular search query, fitting the occurrences of the events in a time window to a reference distribution of occurrences of events to determine a goodness of fit value, wherein the reference distribution models a random occurrence of events relating to search queries, comparing the goodness of fit value to a primary threshold, and classifying the spike as a spurious spike if the goodness of fit value satisfies the predetermined threshold.

### BACKGROUND

This specification relates to classifying a spike in a rate of occurrence of events. Search systems index resources, e.g., social network updates, microblog posts, blog posts, news feeds, user generated multimedia content, images, videos, and web pages, that are relevant to search queries, and present information about the indexed resources to a user in response to receipt of a particular search query.

### SUMMARY

In general, one innovative aspect of the subject matter described in this specification can be embodied in methods that include the actions of receiving data identifying a spike at a particular time in a rate of occurrence of events relating to a particular search query, wherein an event relating to the particular search query is a receipt event of the particular search query or an indexing event of a resource that satisfies the particular search query, fitting the occurrences of the events in a time window to a reference distribution of occurrences of events to determine a goodness of fit value, wherein the reference distribution models a random occurrence of events relating to search queries, comparing the goodness of fit value to a primary threshold, and classifying the spike as a spurious spike if the goodness of fit value satisfies the predetermined threshold. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The reference distribution is a Poisson distribution or a Gaussian distribution. The method of fitting the occurrences of the events includes applying a chi-square goodness of fit test for the reference distribution. The method further includes classifying the spike as a non-spurious spike if the goodness of fit value does not satisfy the primary threshold. If the goodness of fit value does not satisfy the primary threshold, the method further includes determining whether metadata associated with the events relating to the particular search query at the particular time satisfies a suspicious activity condition, and classifying the spike as a non-spurious spike if the metadata does not satisfy the suspicious activity condition. If the metadata satisfies the suspicious activity condition, the method further includes comparing the goodness of fit value to a different, less stringent threshold, and classifying the spike as a spurious spike if the goodness of fit value satisfies the less stringent threshold.

Particular embodiments of the subject matter described in this specification can be implemented so as to realize one or more of the following advantages. The proper classification of spikes improves the quality of search results that are returned to the user in response to a particular search query by suppressing those search results associated with resources that are likely to be spam. The system can detect trending or hot topics in real-time and use such information to provide content recommendations to a user, thereby improving the likelihood that the search results that are returned to the user in response to a particular search query will be of interest to the user. The techniques described in this specification can be used on financial data to identify trending real-time interest in particular stocks.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example search system that includes a front end module, a raw count generator, a spike detection module, a spike classification module and a spike processing module.

FIG. 2 is a flow chart illustrating an example method for classifying a spike in a rate of occurrence of events relating to a particular search query that occur in a particular time window.

Like reference numbers and designations in the various drawings indicate like elements.

### DETAILED DESCRIPTION

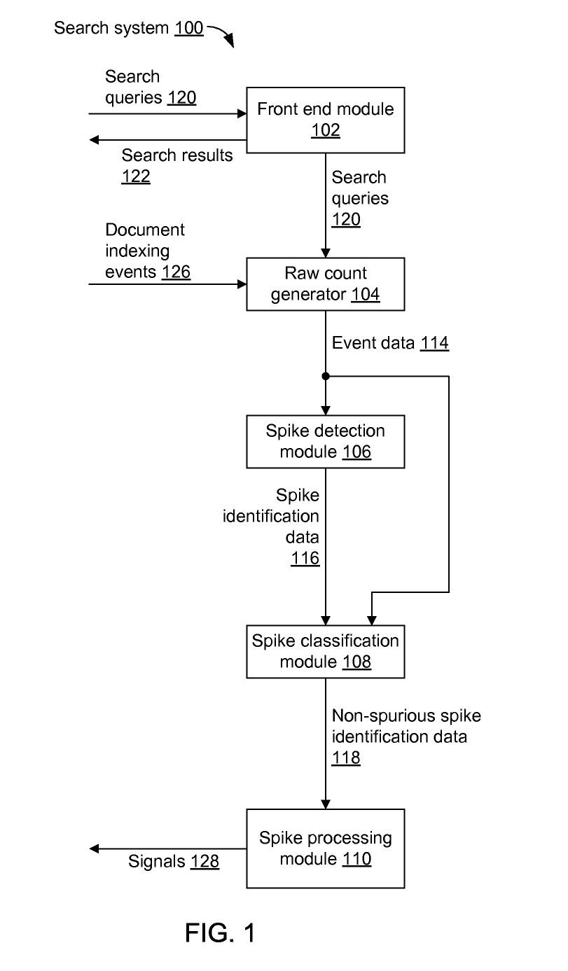

FIG. 1 shows an example search system 100 that includes a front end module 102, a raw count generator 104, a spike detection module 106, a spike classification module 108 and a spike processing module 110.

The front end module 102 provides an interface through which a user operating a user device submits search queries 120 and receives search results 122 that satisfy the search queries 120. The search results 122 identify resources, e.g., web pages, social network updates, microblog posts, blog posts, and user generated multimedia content, which have been indexed by the search system 100.

The front end module 102 passes the search queries 120 to the raw count generator 104, which generates and maintains event data 114. The event data 114 is data about the rate of occurrence of events relating to a particular search query 120. Such events include receipt events and document indexing events 126. Each event is associated with an event time. An event time associated with a receipt event can be the time at which a search query was received by the search system 100, for example, or the time the search query was submitted by a user, or the time a user selected a resource from a search engine results page for viewing. An event time associated with a document indexing event can be the time at which a resource that satisfies a particular search query was indexed by the search system 100, for example, or the time the resource was made publicly available. The raw count generator 104 can be implemented to generate event data 114 by first assigning each event relating to a particular search query to one of a set of bins defined by uniform time intervals according to its associated event time, then generating a raw count per bin. For example, the raw count generator 104 could assign each document indexing event of a resource that satisfies a search query of “San Francisco earthquake” to one of a set of bins defined by five minute intervals, then generate a raw count of the number of events that have been assigned to each bin.

The spike detection module 106 processes the event data 114 using conventional techniques to generate spike identification data 116. The spike identification data 116 identifies the spikes, relative to a historical baseline rate of events, that the spike detection module 106 finds in the rate of occurrence of events. The events can be, for example, events relating to a particular search query over a given time window. In some cases, the time window is a current time window, and the process is performed to identify spikes in current search query activity. The size of the time window can be a predetermined amount of time, e.g., two, five, ten, fifteen, twenty, thirty, forty five, sixty, ninety, or one hundred twenty minutes. In other cases, the process is performed to identify spikes in historical data. Referring to the example above, the spike detection module 106 can analyze the event data 114 for the search query of “San Francisco earthquake” and generate spike identification data 116 that identifies spikes in the number of events over a sixty minute time window.

The spike classification module 108 processes the event data 114 and the spike identification data 116 and classifies each spike in the spike identification data 116 as spurious or non-spurious. The spike classification module 108 generates non-spurious spike identification data 118 that identifies the non-spurious spikes.

The spike processing module 110 processes the non-spurious spike identification data 118 to generate signals 128 for use by the search system 100. For example, the signals 128 can indicate that a particular Internet domain, web site, search query, search topic, web page, image, video, or other resource or a particular author or entity has enjoyed a sudden increase or decrease in popularity, as reflected in search queries that have been submitted or resources that have been viewed. As a particular example, the signals 128 can identify topics of current interest. In some implementations, the spike processing module 110 first identifies, from among the search queries associated with spikes in current search query activity, those search queries that deviated the most from their historic traffic pattern. Using a subsystem of the search system 100 that maps queries to topics, the identified search queries are mapped to topics. Finally, the spike processing module 110 provides a signal that identifies the topics to which the identified search queries are mapped as “topics of current interest.”

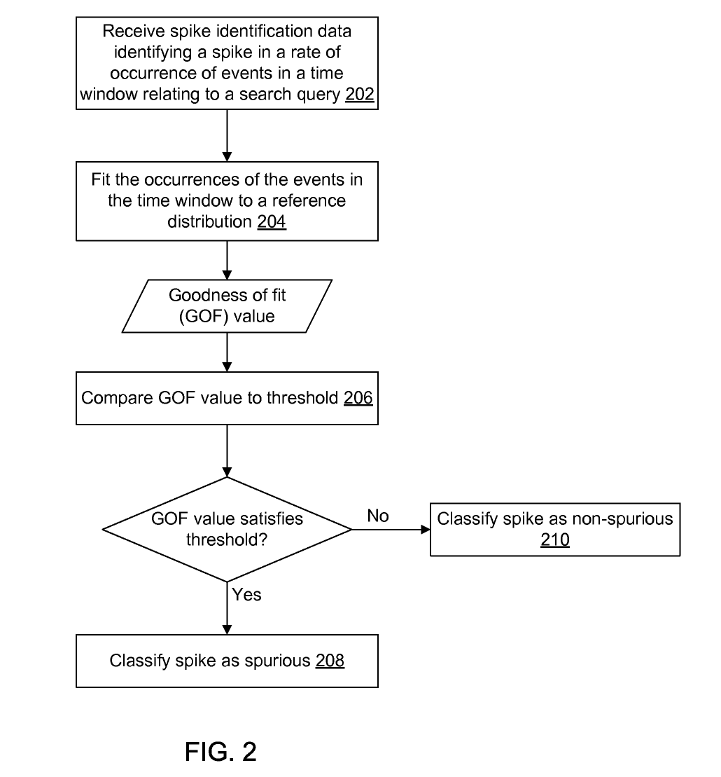

FIG. 2 is a flow chart illustrating an example method for classifying a spike in a rate of occurrence of events relating to a particular search query that occur in a particular time window. For convenience, the method will be described in reference to a system that performs the method. The system can be, for example, the search system 100 described above with reference to FIG. 1.

The spike classification module 108 receives (202) spike identification data identifying a spike in a rate of occurrence of events relating to a particular search query that occur in a particular time window.

The spike classification module 108 fits (204) the occurrences of the events in the time window to a reference distribution of occurrences of events to determine a goodness of fit value. The reference distribution models a random occurrence of events and is a statistical distribution, e.g., a Poisson distribution or a Gaussian distribution. The spike classification module 108 is implemented to apply a chi-square goodness of fit test, a likelihood-ratio test, a G-test, or other suitable test depending on the reference distribution. Next, the spike classification module 108 compares (206) the goodness of fit (“GOF”) value to a predetermined primary threshold. If the GOF value satisfies the primary threshold, e.g., a chi-square statistic is less than the chi-square critical value at p=0.05 significance level, the spike classification module 108 classifies (208) the spike as a “spurious” spike. Otherwise, the spike classification module 108 classifies (210) the spike as “non-spurious.”

In some implementations of the spike classification module 108, if the GOF value does not satisfy the primary threshold but satisfies a less stringent secondary threshold, e.g., a chi-square statistic which is less than the chi-squared critical value for p between 0.05 and 0.10, the spike classification module 108 examines metadata for the events associated with the spike to determine whether the metadata satisfies a suspicious activity condition. Examples of metadata that satisfies a suspicious activity condition include metadata identifying a single entity, e.g., IP address, email address, author, or username, as the source of a significant portion, e.g., more that 10%, 20%, 30%, 40%, or 50%, of the events associated with the spike. If the metadata satisfies the “suspicious activity” condition, the spike is classified as a “spurious” spike; otherwise, if the metadata does not satisfy the condition, the spike is classified as a “non-spurious” spike.

In some implementations of the spike classification module 108, if the GOF value does not meet the primary threshold, the spike classification module 108 first examines the metadata for the events associated with the spike to determine whether the metadata satisfies the suspicious activity condition. If the metadata does not satisfy the suspicious activity condition, the spike classification module 108 classifies the spike as “non-spurious.” Otherwise, the spike classification module 108 compares the GOF value to a different, less stringent threshold, and classifies the spike as “spurious” only if the GOF value satisfies the less stringent threshold.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions encoded on a computer storage medium for execution by, or to control the operation of, data processing apparatus. Alternatively or in addition, the program instructions can be encoded on a propagated signal that is an artificially generated signal, e.g., a machine generated electrical, optical, or electromagnetic signal, that is generated to encode information for transmission to suitable receiver apparatus for execution by a data processing apparatus. The computer storage medium can be a machine readable storage device, a machine readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

In some implementations, the raw count generator 104 is integrated with the spike detection module 106. In some implementations, the spike classification module 108 is integrated with the spike detection module 106. In some implementations, the raw count generator 104, the spike detection module 106, and the spike classification module 108 are integrated into one module.

In some implementations, a spike classification module uses the techniques described above to classify spikes in the rate of occurrence of document indexing events relating to a particular search query.

In some implementations, a system uses the techniques described above to detect trending topics and recommend content associated with trending topics to users.

In some implementations, a system includes multiple spike classification modules operating in parallel, where each spike classification module is configured to fit the occurrences of the events in the time window to a distinct reference distribution of occurrences of events to determine a goodness of fit value, which is subsequently compared to a predetermined threshold that is specific to the reference distribution.

What is claimed is:

1. A computer-implemented method comprising:
receiving data identifying a spike at a particular time in a rate of occurrence of events relating to a particular search query, wherein an event relating to the particular search query is a receipt event of the particular search query or an indexing event of a resource that satisfies the particular search query;
fitting the occurrences of the events in a time window to a reference distribution of occurrences of events to determine a goodness of fit value, wherein the reference distribution models a random occurrence of events relating to search queries;
comparing the goodness of fit value to a primary threshold; and
classifying the spike as a spurious spike if the goodness of fit value satisfies the predetermined threshold.

2. The computer-implemented method of claim 1, wherein the reference distribution is a Poisson distribution or a Gaussian distribution.

3. The computer-implemented method of claim 1, wherein fitting the occurrences of the events comprises:
applying a chi-square goodness of fit test for the reference distribution.

4. The computer-implemented method of claim 1, further comprising:
classifying the spike as a non-spurious spike if the goodness of fit value does not satisfy the primary threshold.

5. The computer-implemented method of claim 1, wherein, if the goodness of fit value does not satisfy the primary threshold, the method further comprises:
determining whether metadata associated with the events relating to the particular search query at the particular time satisfies a suspicious activity condition; and
classifying the spike as a non-spurious spike if the metadata does not satisfy the suspicious activity condition.

6. The computer-implemented method of claim 5, wherein, if the metadata satisfies the suspicious activity condition, the method further comprises:
comparing the goodness of fit value to a different, less stringent threshold; and
classifying the spike as a spurious spike if the goodness of fit value satisfies the less stringent threshold.

7. A computer-readable storage medium storing instructions that, when executed by one or more computers, cause the one or more computers to perform a method comprising:
receiving data identifying a spike at a particular time in a rate of occurrence of events relating to a particular search query, wherein an event relating to the particular search query is a receipt event of the particular search query or an indexing event of a resource that satisfies the particular search query;
fitting the occurrences of the events in a time window to a reference distribution of occurrences of events to determine a goodness of fit value, wherein the reference distribution models a random occurrence of events relating to search queries;
comparing the goodness of fit value to a primary threshold; and
classifying the spike as a spurious spike if the goodness of fit value satisfies the predetermined threshold.

8. The computer-readable storage medium of claim 7, wherein the reference distribution is a Poisson distribution or a Gaussian distribution.

9. The computer-readable storage medium of claim 7, wherein the method for fitting the occurrences of the events comprises:
applying a chi-square goodness of fit test for the reference distribution.

10. The computer-readable storage medium of claim 7, wherein the method further comprises:
classifying the spike as a non-spurious spike if the goodness of fit value does not satisfy the primary threshold.

11. The computer-readable storage medium of claim 7, wherein, if the goodness of fit value does not satisfy the primary threshold, the method further comprises:
determining whether metadata associated with the events relating to the particular search query at the particular time satisfies a suspicious activity condition; and
classifying the spike as a non-spurious spike if the metadata does not satisfy the suspicious activity condition.

12. The computer-readable storage medium of claim 11, wherein, if the metadata satisfies the suspicious activity condition, the method further comprises:
comparing the goodness of fit value to a different, less stringent threshold; and
classifying the spike as a spurious spike if the goodness of fit value satisfies the less stringent threshold.

13. A system comprising:
one or more computers;
a computer-readable storage medium storing instructions that, when executed by the one or more computers, cause the one or more computers to perform a method comprising:
receiving data identifying a spike at a particular time in a rate of occurrence of events relating to a particular search query, wherein an event relating to the particular search query is a receipt event of the particular search query or an indexing event of a resource that satisfies the particular search query;
fitting the occurrences of the events in a time window to a reference distribution of occurrences of events to determine a goodness of fit value, wherein the reference distribution models a random occurrence of events relating to search queries;
comparing the goodness of fit value to a primary threshold; and
classifying the spike as a spurious spike if the goodness of fit value satisfies the predetermined threshold.

14. The system of claim 13, wherein the reference distribution is a Poisson distribution or a Gaussian distribution.

15. The system of claim 13, wherein the method for fitting the occurrences of the events comprises:
applying a chi-square goodness of fit test for the reference distribution.

16. The system of claim 13, wherein the method further comprises:
classifying the spike as a non-spuriuos spike if the goodness of fit value does not satisfy the primary threshold.

17. The system of claim 16, wherein, if the goodness of fit value does not satisfy the primary threshold, the method further comprises:
determining whether metadata associated with the events relating to the particular search query at the particular time satisfies a suspicious activity condition; and
classifying the spike as a non-spurious spike if the metadata does not satisfy the suspicious activity condition.

18. The system of claim 13, wherein, if the metadata satisfies the suspicious activity condition, the method further comprises:
comparing the goodness of fit value to a different, less stringent threshold; and
classifying the spike as a spurious spike if the goodness of fit value satisfies the less stringent threshold.
